(19) United States
(12) Patent Application Publication
(10) Pub. No.: US 2015/0220941 A1
(43) Pub. Date: Aug. 6, 2015

(54) VISUAL TAGGING TO RECORD INTERACTIONS

(71) Applicant: Fractal Sciences Inc., San Francisco, CA (US)

(72) Inventors: Lior Tamir, San Francisco, CA (US); Idan Benaim, San Mateo, CA (US); Shaun Porcar, Burlingame, CA (US)

(73) Assignee: Fractal Sciences Inc., San Francisco, CA (US)

(21) Appl. No.: 14/172,798

(22) Filed: Feb. 4, 2014

(51) Int. Cl. G06Q 30/02

(52) U.S. Cl. CPC G06Q 30/0201

(57) ABSTRACT

Digital content can be tagged to record potential interactions, causing each occurrence of the tagged interaction to be recorded. A source document defining the digital content can be scanned to identify each featured area along with the potential interactions that each of the featured areas is configured to receive, which can then be presented over a visual representation of the digital content where they can be tagged, thereby causing each occurrence of the tagged interaction to be recorded. An entry in a recording index including an featured area identifier, an interaction identifier and an interaction count, can then be created. Upon receiving a reporting message identifying a detected interaction on the digital content, the reporting index can be searched for an entry corresponding to the detected interaction. If an entry is found, the interaction count can be incremented to record the detected occurrence of the tagged interaction.

### TECHNICAL FIELD

The present technology pertains to recording interaction with digital content, and more specifically pertains to visually tagging digital content to record specified interactions with the digital content.

### BACKGROUND

With the emergence of the worldwide web and mobile devices, businesses have begun investing heavily into their online and mobile presence using various types of digital content. With this heavy investment comes a desire to gauge the performance and effectiveness of digital content such as websites, mobile applications, marketing campaigns, etc., and ideally to optimize each to achieve the greatest return on investment.

One way performance of digital content is gauged is by tracking interactions with the digital content. This can include tracking user interactions with featured areas of the digital content, such as links, buttons, menu items, static images, videos, etc. To track interactions, current systems require a web administrator to manually enter tracking code into the source document defining the digital content, which transmits a reporting message when a specified interaction occurs. To track interactions with a specified featured area, such as a link presented in the digital content, the tracking code must be entered at the correct portion of the source document that defines the link. This requires a highly skilled programmer to identify the code associated with each of the featured areas to be tracked and can result in multiple instances of the tracking code being individually entered throughout the source document. As a result, implementing these types of tracking systems can be difficult and time consuming.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for visually tagging selected interactions with digital content for recording. Digital content can include featured areas that can be selected for tagging. A featured area can be any area of the digital content that is prominent, unique or integrated into the functionality of the digital content. For example, a featured area can include an actionable item of the digital content that is configured to receive one or more potential interactions, such as a button, checkbox, link, etc., configured to receive an interaction such as a selection, scroll, etc. Alternatively, a featured area can include a prominent item of the digital content that may not be actionable, such as a static image, title, heading, etc.

Digital content can be tagged to record some or all of the potential interactions with the digital content, causing each occurrence of the tagged interaction to be recorded. For example, a webpage can be tagged so that each selection of a specified link presented on the webpage is recorded. Alternatively, a mobile application can be tagged so that each selection of specified link of the mobile application is recorded

To facilitate visual tagging of digital content, a source document defining the digital content can be scanned to identify each featured area of the digital content along with the potential interactions that each of the featured areas is configured to receive. The featured areas of the digital content can be identified by scanning the source document defining the digital content for specified tags or social cues indicating that a portion of the source document defines a featured area of the digital content. The identified portion of the source document can then be analyzed to identify the potential interactions enabled by the featured area.

The identified featured areas can be presented over a visual representation of the digital content where they can be selected by a user to tag one or more potential interactions with the featured area, thereby causing each occurrence of the tagged interaction to be recorded. For example, a user can select the featured area where the interaction can occur as well as the specified interaction the user would like to tag, thereby causing each instance of the tagged interaction on the featured area to be recorded.

An entry in a recording index associated with the digital content can be created for each tagged interaction. Each entry in the reporting index can include a featured area identifier identifying the featured area and an interaction identifier identifying the specified interaction to be recorded. Each entry can also include an interaction count indicating each detected instance of the tagged interaction.

A reporting script generated for the digital content can be inserted into the source document defining the digital content. The reporting script can cause reporting messages identifying interactions detected on the digital content to be transmitted to a reporting server that manages reporting for the digital content. A reporting message can include a digital content identifier identifying the digital content on which the interaction occurred, a featured area identifier identifying the featured area where the detected interaction occurred, and an interaction identifier identifying the type of interaction detected.

The data in the reporting message can be used to identify the reporting index associated with the digital content and determine if there is an entry in the reporting index corresponding to the detected interaction. If an entry corresponding to the detected interaction is found, the interaction count for the entry can be incremented to indicate that an instance of the tagged interaction was detected. The data in the reporting index can then be used to generate reports regarding interaction with the digital content.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 shows an exemplary configuration of devices and a network in accordance with the invention;

FIG. 2 illustrates an exemplary method embodiment of visually tagging digital content for reporting;

FIG. 3 illustrates an exemplary method embodiment of recording occurrences of a tagged interaction with digital content;

FIG. 4 illustrates an exemplary embodiment of a reporting interface; and

FIGS. 5A and 5B illustrate exemplary possible system embodiments.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for visually tagging selected interactions with digital content for recording. Digital content can include featured areas that can be selected for tagging. A featured area can be any area of the digital content that is prominent, unique or integrated into the functionality of the digital content. For example, a featured area can include an actionable item of the digital content that is configured to receive one or more potential interactions, such as a button, checkbox, link, etc., configured to receive an interaction such as a selection, scroll, etc. Alternatively, a featured area can include a prominent item of the digital content that may not be actionable, such as a static image, title, heading, etc.

Digital content can be tagged to record some or all of the potential interactions with the digital content, causing each occurrence of the tagged interaction to be recorded. For example, a webpage can be tagged so that each selection of a specified link presented on the webpage is recorded. Alternatively, a mobile application can be tagged so that each selection of specified link of the mobile application is recorded.

To facilitate visual tagging of digital content, a source document defining the digital content can be scanned to identify each featured area of the digital content along with the potential interactions that each of the featured areas is configured to receive. The featured areas of the digital content can be identified by scanning the source document defining the digital content for specified tags or social cues indicating that a portion of the source document defines a featured area of the digital content. The identified portion of the source document can then be analyzed to identify the potential interactions enabled by the featured area.

The identified featured areas can be presented over a visual representation of the digital content where they can be selected by a user to tag one or more potential interactions with the featured area, thereby causing each occurrence of the tagged interaction to be recorded. For example, a user can select the featured area where the interaction can occur as well as the specified interaction the user would like to tag, thereby causing each instance of the tagged interaction on the featured area to be recorded.

An entry in a recording index associated with the digital content can be created for each tagged interaction. Each entry in the reporting index can include a featured area identifier identifying the featured area and an interaction identifier identifying the specified interaction to be recorded. Each entry can also include an interaction count indicating each detected instance of the tagged interaction.

A reporting script generated for the digital content can be inserted into the source document defining the digital content. The reporting script can cause reporting messages identifying interactions detected on the digital content to be transmitted to a reporting server that manages reporting for the digital content. A reporting message can include a digital content identifier identifying the digital content on which the interaction occurred, a featured area identifier identifying the featured area where the detected interaction occurred, and an interaction identifier identifying the type of interaction detected.

The data in the reporting message can be used to identify the reporting index associated with the digital content and determine if there is an entry in the reporting index corresponding to the detected interaction. If an entry corresponding to the detected interaction is found, the interaction count for the entry can be incremented to indicate that an instance of the tagged interaction was detected. The data in the reporting index can then be used to generate reports regarding interaction with the digital content.

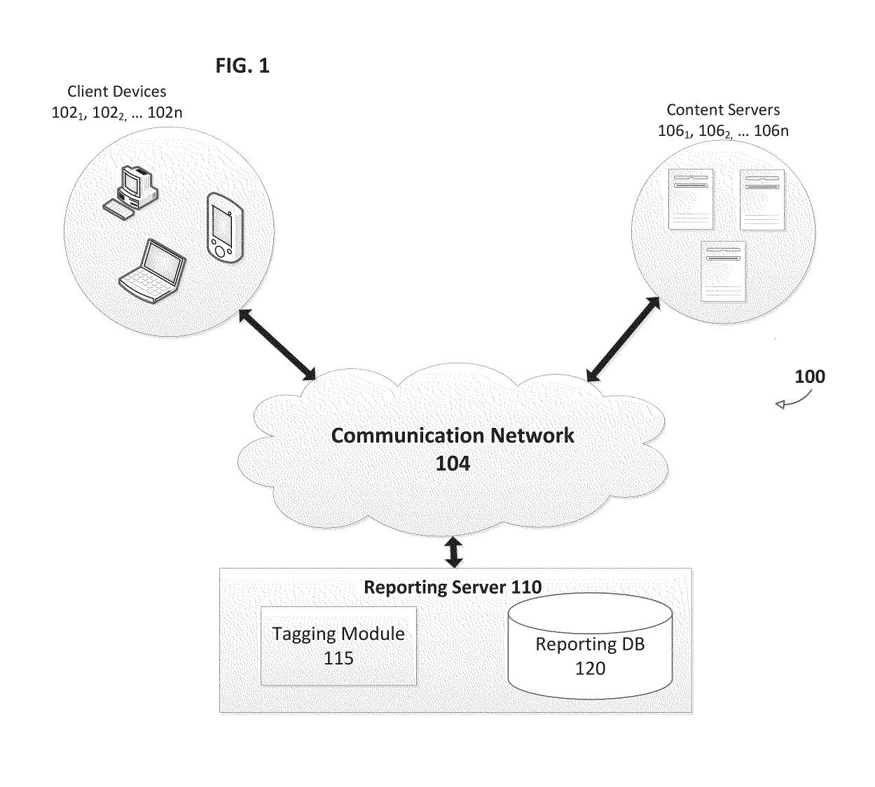

FIG. 1 illustrates an exemplary system configuration 100, wherein electronic devices communicate via a network for purposes of exchanging content and other data. As illustrated, multiple computing devices can be connected to communication network 104 and be configured to communicate with each other through use of communication network 104.

Communication network 104 can be any type of network, including a local area network (“LAN”), such as an intranet, a wide area network (“WAN”), such as the internet, or any combination thereof. Further, communication network 104 can be a public network, a private network, or a combination thereof. Communication network 104 can also be implemented using any number of communications links associated with one or more service providers, including one or more wired communication links, one or more wireless communication links, or any combination thereof. Additionally, communication network 104 can be configured to support the transmission of data formatted using any number of protocols.

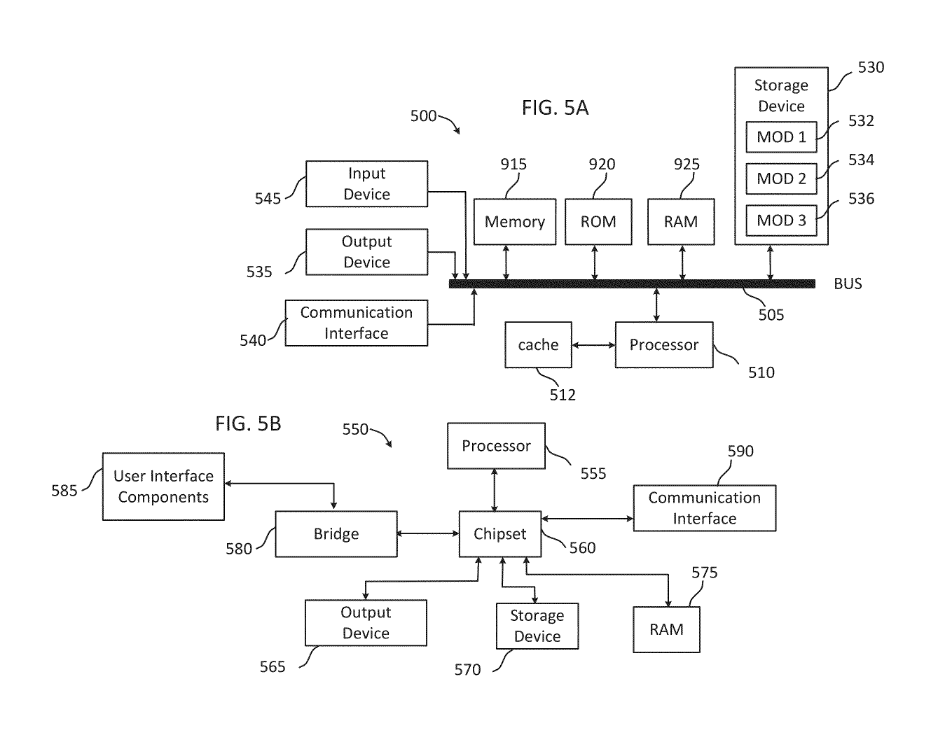

Multiple computing devices can be connected to communication network 104. A computing device can be any type of general computing device capable of network communication with other computing devices. For example, a computing device can be a personal computing device such as a desktop or workstation, a business server, or a portable computing device, such as a laptop, smart phone, or a tablet PC. A computing device can include some or all of the features, components, and peripherals of computing device 5 of FIGS. 5A and 5B.

To facilitate communication with other computing devices, a computing device can also include a communication interface configured to receive a communication, such as a request, data, etc., from another computing device in network communication with the computing device and pass the communication along to an appropriate module running on the computing device. The communication interface can also be configured to send a communication to another computing device in network communication with the computing device.

As illustrated, system 100 includes content servers 106₁ . . . 106ₙ (collectively “106”), reporting server 110 and client devices 102₁ . . . 102ₙ (collectively “102”), connected to communication network 104 to communicate with each other to transmit and receive data. In system 100, digital content can be delivered to client devices 102 connected to communication network 104 by direct and/or indirect communications with content servers 106. In particular, content server 106ᵢ can receive a request from client device 102ᵢ for a digital content package of electronic digital content, such as a web page, application, game, media, etc., managed by content server 106ᵢ. In the various embodiments, one or more types of digital content can be combined in a digital content package, such as images, audio, text, video, executable code or any combination thereof.

Client devices 102 can be configured to render the received digital content package. This can include display or playing the digital content appropriately depending on the form of the digital content, such as text, graphics, audio, video, executable code or any combination thereof. For example, client devices 102 can include a web browser application capable of processing the received digital content package, including a source document defining a webpage, application, etc., and rendering the digital content defined by the source document. Alternatively, client devices 102 can include a client-side application capable of processing the received digital content package and rendering the digital content.

Further, the web browser or client-side application can enable a user of client device 102ᵢ to interact with the rendered digital content. This can include selecting or interacting with featured areas of the rendered digital content. The web browser or client side application can execute any actions resulting from an interaction with a featured area of the digital content, such as requesting a new content package from one of content servers 106, playing audio or video, adding an item to a shopping cart, etc.

In some embodiments, the digital content can be a native application designed to execute on a specified platform. For example, the digital content can be designed to execute on client devices running a specific operating system. The source document defining the native application can be downloaded from one of content servers 106. Alternatively, the source document can be installed from a disk or other computer readable medium.

System 100 can also include reporting server 110 configured to enable visual tagging of digital content to facilitate reporting tagged interactions. Interactions with featured areas of digital content can be monitored to gather metrics regarding use of the digital content. An interaction can include performance of specific actions enabled by an actionable featured area or an action enabled by a client device rendering the digital content. For example, a featured area such as a button can be configured to receive an interaction such as selection or clicking of the button. Alternatively, a featured area such as a checkbox can be configured to receive multiple interactions such as selecting or unselecting the checkbox.

An interaction can also include actions enabled by the client device that are not directly tied to the featured area. For example, a client device can enable a user to zoom in to any portion of the rendered digital content or hover over a featured area with a mouse pointer, finger, etc. An interaction can include any action enabled by the client device, even if the action is not specifically enabled by the featured area and even if the featured area is not actionable to receive any specific actions. For example, an interaction can be a user pinching a touch screen to zoom in to static image or text presented in the digital content.

Although specific examples of interactions are listed given, these are only some possible interactions that can be tagged and are not meant to be limiting. One skilled in the art would recognize that any type of interaction can be tagged using the concepts explained in this disclosure, and this disclosure contemplates all such possibilities. For example, interactions can include any meaningful event such as selecting, clicking, scrolling, swiping, pinching, tapping, hovering, ajax calls, selecting an icon in embedded video, etc.

Reporting server 110 can be configured to identify the featured areas of digital content and the potential interactions, including the interactions that each featured area is configured to receive as well as those enabled by the client device, and present this information on a visual representation of the digital content. A user can then interact with the visual representation to tag any of the potential interactions for reporting.

To accomplish this, reporting server 110 can include tagging module 115 that facilitates visual tagging of digital content. Tagging module 115 can be configured to present a tagging interface enabling a user to identify digital content to be visually tagged for reporting. A user can access reporting server 110 using a computing device such as one of client device 102 in network communication with reporting server 110. For example, client device 102ᵢ can access reporting server 110 using a web browser application to request and render the tagging interface. Alternatively, in some embodiments, client device 102ᵢ can access reporting server 110 using a client-side application configured to access reporting server 110 and render the tagging interface.

The tagging interface can be designed to enable a user to select digital content that the user would like to tag for reporting. For example, in some embodiments, the reporting interface can enable a user to enter a Uniform Resource Locator (URL) associated with the digital content. Tagging module 115 can use the entered URL to request the source document defining the identified digital content from a content server managing the digital content. Alternatively, in some embodiments, the tagging interface can enable a user to upload the source document defining the digital content. For example, the source documents can be uploaded form the client device used to access the tagging interface.

Reporting module 115 can generate a reporting script for the selected digital content. The reporting script can be a script that, when included in a source document defining the digital content, causes a reporting message to be transmitted to reporting server 110 when one or more specified triggers occurs. For example, client device 102ᵢ can render a source document including the reporting script to present the digital content. The reporting script can cause client device 102ᵢ to generate and transmit a reporting message to reporting server 110 upon a specified trigger occurring.

In some embodiments, the trigger can be detection of an interaction with the digital content. Alternatively, trigger can be a time based trigger such that the reporting script causes the reporting message to be transmitted periodically or according to a specified schedule.

The reporting message can include data identifying the digital content and any detected interactions. For example, to identify the digital content, in some embodiments, the reporting message can include a digital content identifier generated by tagging module 115 that identifies the digital content. Tagging module 115 can include the digital content identifier in the reporting script, which can then be transmitted in each reporting message to identify the digital content. Alternatively, in some embodiments, the reporting message can include a URL or portion of the URL to identify the digital content.

To identify the detected interaction, the reporting message can include a featured area identifier identifying the featured area at which the detected interaction occurred. For example, to identify a detected interaction such as a selection of a link, the featured area identifier can identify the link that was selected.

The reporting message can further include an interaction identifier identifying the type of interaction performed on the featured area. For example, the interaction identifier can identify that the featured area was selected or deselected. Alternatively, the interaction identifier can indicate a potential input that was selected. For example, a featured area such as a dropdown box can provide a user with several potential inputs to select from and the interaction identifier can identify the input that was received.

In some embodiments, the reporting script can be configured to mark a client device with a client device identifier that identifies the client device rendering the digital content. For example, upon client device 102ᵢ rendering digital content including the reporting script, the reporting script can mark client device 102ᵢ with an identifier uniquely identifying client device 102ᵢ. Reporting messages transmitted by client device 102ᵢ can include the client device identifier indicating that the detected interaction was received from client device 102ᵢ.

In some embodiments, the client device identifier can be stored in memory on the client device. For example, the client device identifier can be stored as a cookie accessible to a web browser application rendering the digital content. The reporting script can cause the client device to gather the stored client device identifier and transmit it as part of a reporting message transmitted to reporting server 110.

In some embodiments, the reporting message can include other data gathered from the rendering client device and/or the detected interaction. For example, the reporting message can include device data regarding the rendering client device, such as device type, web browser type, geographic information, network connection type, current settings, application running, etc. The reporting script can gather any of this data from the client device and include the data in the reporting message.

Further, in some embodiments, the reporting message can include data received from the detected interaction. The data from the detected interaction can include data entered as part of the interaction, such as text, numbers, etc., entered into a text box. Alternatively, the data from the detected interaction can include location data regarding the interaction, such as the pixel location where the interaction occurred on the screen of the client device. Alternatively, the data from the detected interaction can include data identifying the product or pricing information associated with the interaction.

Reporting module 110 can be configured to provide the generated reporting script so that the reporting script can be entered into the source document defining the digital content. For example, the reporting script can be presented as text in the reporting interface where it can be copied and then pasted into the source document. Alternatively, in some embodiments, the reporting script can be provided as a file, such as a text file. The text file can be transmitted to client device 102ᵢ where the reporting script can then be entered into the source document.

Tagging module 115 can also create a reporting index for the identified digital content. A reporting index can be an index that includes an entry for each interaction with the digital content that has been tagged for reporting. Reporting server 110 can include reporting database 120 and tagging module 115 can be configured to communicate with reporting database 120 to store the generated reporting index, which can then be readily accessed and modified.

A generated reporting index can be labeled or tagged to associate the reporting index with the specified digital content. For example the digital content can be labeled or tagged with a digital content identifier generated by tagging module 115 to identify the digital content. Alternatively, the reporting index can be tagged or labeled with a URL or portion of a URL identifying the digital content.

Tagging module 115 can also be configured to identify featured areas of the digital content as well as the interaction that each featured area is configured to receive. To accomplish this, tagging module 115 can scan the source document defining the digital content for specified tags or social cues indicating that a portion of the source document defines a featured area. For example, tags identifying actionable user interface elements such as buttons, checkboxes, textboxes, dropdown boxes, etc., can indicate that a portion of the source document defines a featured area. Tagging module 115 can scan the source document for specified tags to identify portions of the source document that define a featured area. Further, tags identifying prominent features of the digital content, such as images, headings, etc., can indicate that a portion of the source document defines a featured area.

Alternatively, certain social cues can indicate that a portion of the source document defines a featured area. For example, text such as confirm, next, add, etc. can indicate that the portion of the source document defines a featured area configured to perform one of the described functions. Size and location can also be a social cue indicating that portion of the source document defines a featured area. For example, images, text, etc., that are presented in a larger size or font can be determined to be a featured area. Alternatively, text or images placed in the middle or top of a page can be determined to be a featured area. Tagging module 115 can be configured to scan the source document for social cues to identify portions of the source document that define a featured area.

Tagging module 115 can further analyze the portions of the source document that define a featured area to determine the interactions that each featured area is configured to receive. For example, tagging module 115 can analyze the source document to determine whether the featured area is an actionable item and, if so, what interactions the actionable item is configured to receive.

Tagging module 115 can present the identified featured areas in the tagging interface to enable a user to tag interactions for reporting. In some embodiments, the identified featured areas can be presented over a visual representation of the digital content. For example, the identified featured areas can be outlined or highlighted on the visual representation of the digital content. Alternatively, the featured areas can be highlighted when a user hovers over the featured area.

To tag an interaction for reporting, the tagging interface can be configured to enable a presented featured area and corresponding interaction to be selected. For example, a featured area such as dropdown box can be selected by clicking on the dropdown box. The corresponding interactions can then be presented and one or more can be selected and tagged for recording.

The tagging module 115 can also enable a user to enter reporting data describing a tagged interaction. For example, the reporting data can include a title, context, etc. for the tagged interaction, which can later be used for reporting purposes.

For each tagged interaction, tagging module 115 can create an entry in the reporting index associated with the digital content. For example, upon a user tagging an interaction for reporting, tagging module 115 can access the reporting index in reporting database 120 and create a new entry in the reporting index. The new entry can include a featured area identifier and an interaction identifier that identify the tagged interaction. For example the featured area identifier can identify the featured area where the tagged interaction can occur, and the interaction identifier can identify the specific interaction that is tagged.

The entry in the recording index can also include an interaction count indicating the number of times the tagged interaction has been detected. The interaction count can initially be set to zero. The new entry can also include any reporting data provided by a user. The entry can also include numerous other counts for tracking any other desired metric, such as location, client device type, time, etc. For example, in some embodiments, the reporting interface can enable a user to select the various metrics the user would like to track. This data can then be used when generating the recording index and each entry to ensure that each selected metric is recorded. Further, the entered data can be used to generate an recording script configured to gather the requested data and include it in reporting messages transmitted to reporting server 110.

To record an occurrence of the tagged interaction, tagging module 115 can be configured to receive reporting requests from client devices 105. For example, client device 102ᵢ can request and render a source document that includes a reporting script generated by reporting server 110. The reporting script can cause the client device 102ᵢ to generate and transmit the reporting request to reporting server 110.

Tagging module 115 can be configured to receive reporting messages from client devices 105, and determine if a detected interaction identified by the reporting request is a tagged interaction. Upon receiving a reporting message, tagging module 115 can identify the appropriate reporting index from data included in the reporting message. For example, a digital content identifier included in the reporting message can be used by tagging module 115 to search reporting database 120 for the reporting index tagged or labeled with the matching digital content identifier. Alternatively, a URL or portion of a URL included in the reporting message can be used to search reporting database for the corresponding reporting index.

Upon identifying the correct reporting index, tagging module 115 can search the reporting index for an entry matching the detected interaction. For example, tagging module 115 can search the reporting index for an entry including the featured area identifier and interaction identifier included in the reporting message. If a matching entry is found, the interaction count associated with the entry can be incremented to indicate that an occurrence of the tagged interaction was detected.

In some embodiments, the tagging module 115 can be configured to identify detected interactions that are fraudulent interactions. For example, the fraudulent interactions may be the result of a script or some other code meant to repetitively cause the interaction to increase impressions. Tagging module 115 can identify fraudulent interactions based on the data included in the reporting message. For example, repetitive interactions received from the same client device or a client device known to be associated with fraudulent interactions can be determined to be fraudulent. Detected interactions determined to be fraudulent can be disregarded by tagging module 115, meaning that the detected interaction will not be recorded in the reporting index.

Reporting server 110 can further be configured to use the data gathered in the reporting index to provide detailed analytics regarding interactions with the tagged digital content. For example, reporting server 110 can provide the analytics data in a visual format such as a chart, graph, heat map, histogram, etc.

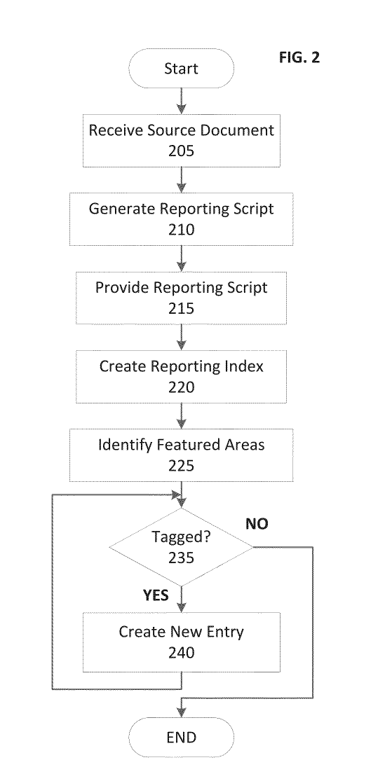

FIG. 2 illustrates an exemplary method embodiment of visually tagging digital content for reporting. Although specific steps are show in FIG. 2, in other embodiments the method can have more or less steps. As shown the method begins at block 205 where a source document is received for tagging. A source document can be received in multiple ways. For example, in some embodiments, a user can provide a URL for the digital content and the source document can be gathered using the URL. Alternatively, a source document can be uploaded by a user.

The method then continues to block 210 where a reporting script is generated for the source document. The reporting script can be a script that, when included in the source document, causes a reporting message to be transmitted to a reporting server to report detected interactions with the digital content. For example, upon detecting an interaction with the digital content, such as a selection of a featured area of the digital content, the reporting script can cause the client device rendering the digital content to transmit a reporting message to the reporting server. The reporting message can include a digital content identifier identifying the digital content, as well as a featured area identifier and interaction identifier identifying the detected interaction. The reporting message can also include data gathered from a client device rendering the digital content, data received as part of the interaction, or item or pricing data associated with the detected interaction.

The method then continues to block 215 where the generated reporting script is provided to be entered into the source document. For example, the reporting script can be provided as text which can be copied and then pasted into the source document. Alternatively, the reporting script can be provided in a file, such as a text file, which can then be used to insert the script into the source document.

The method then continues to block 220 where a reporting index is created for the digital content. The reporting index can identify the digital content, for example, by being labeled or tagged with a digital content identifier identifying the digital content.

The method then continues to block 225 where featured areas of the digital content and their corresponding potential interactions are identified. This can be accomplished by scanning the source document defining the digital content for specified tags and/or social cues that indicate that a portion of the source document defines a featured area.

The method then continues to block 230 where the identified featured areas and their corresponding potential interactions are presented so that the interactions can be tagged for reporting. For example, the featured areas can be presented over a visual representation of the digital content, which can be selected.

At block 235, the method determines if an interaction is tagged for reporting. For example, a featured area and its corresponding potential interactions can be presented to enable selection of the featured area and at least one of the corresponding interactions, selection of which results in the selected interaction on the featured area being tagged for reporting. Tagging data regarding the featured area, such as designating a title, context, etc., for the tagged interaction can also be received.

If at block 235 it is determined that an interaction has been tagged for reporting, the method continues to block 240 where an entry in the reporting index is created for the tagged interaction. The created entry can include an featured area identifier and interaction identifier that identify the tagged interaction. The entry can also include an interaction count indicating the number of times the tagged interaction has been detected. The interaction count can initially be set to zero. The entry can also include any tagging data provided by the user.

After the entry in the reporting index has been created, the method return to block 235 where it is determined if another interaction has been tagged for reporting. If at block 235 it is determined that no other interactions have been tagged for reporting, the method ends.

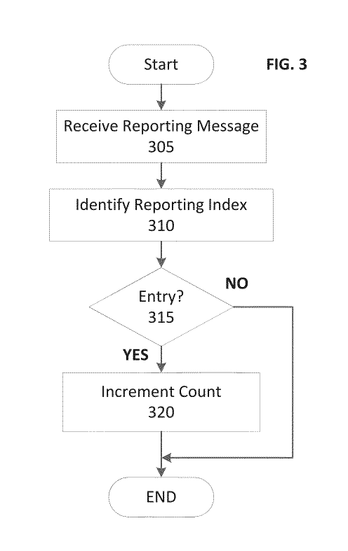

FIG. 3 illustrates an exemplary method embodiment of recording occurrences of a tagged interaction on a webpage. Although specific steps are show in FIG. 3, in other embodiments the method can have more or less steps. As shown the method begins at block 305 with a reporting message being received. A reporting request can be received from a client device processing a source document to render digital content. A reporting script included in the source document can cause the client device to transmit the reporting message upon a specified trigger occurring. For example, the reporting script can cause the client device to transmit the reporting message upon detection of an interaction on the digital content.

The reporting message can include a digital content identifier identifying the digital content and a featured area identifier and interaction identifier identifying the detected interaction. The reporting message can also include other data gathered from the client device, detected interaction or associated with the featured area.

Upon receiving the reporting message, the method continues to block 310 where the reporting index for the digital content is identified. This can be accomplished by searching for a reporting index that is labeled or tagged with the digital content identifier included in the reporting request. The digital content identifier can be a unique identifier generated to identify the digital content. Alternatively, the digital content identifier can be a URL or a portion of a URL that identifies the digital content.

At block 315 it is determined whether there is an entry in the reporting index that matches the detected interaction. For example, the reporting index can be searched for an entry that includes a featured area identifier and interaction identifier matching the featured area identifier and interaction identifier included in the reporting message.

If at block 315 it is determined that there is an entry in the reporting index matching the detected interaction, the method continues to block 320 where the interaction count associated with the entry is incremented to indicate that an occurrence of the tagged interaction has been detected. Further, in some embodiments, a count associated with other selected metrics can be incremented based on the data included in the reporting message. The method then ends.

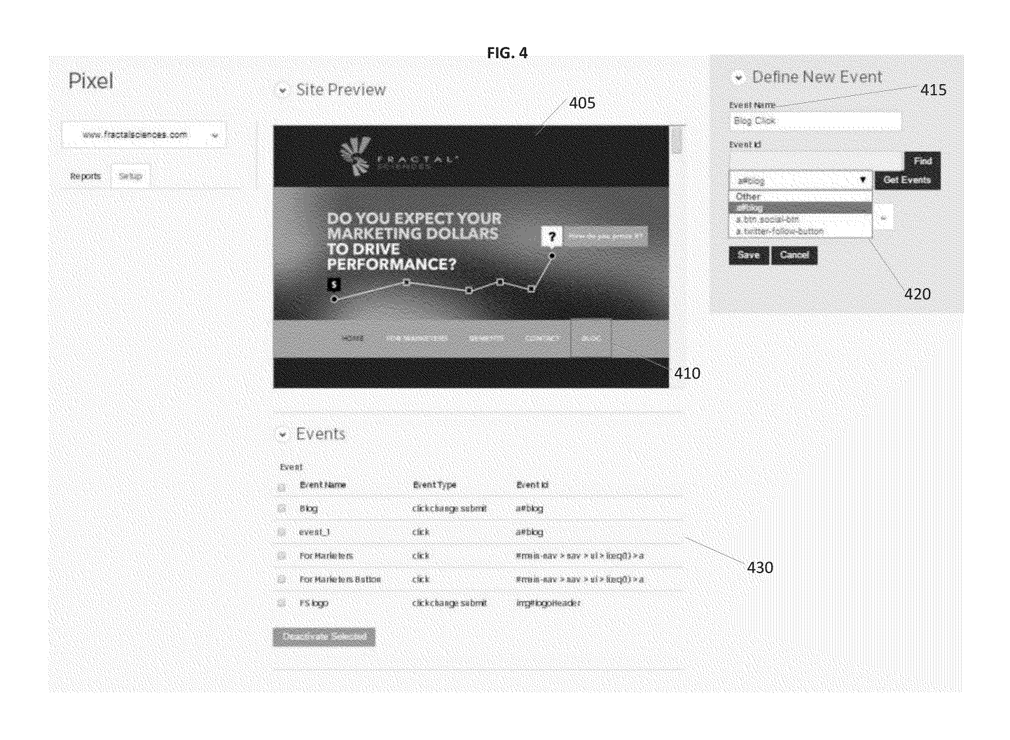

FIG. 4 illustrates an exemplary embodiment of a reporting interface. As shown, reporting interface 400 includes a visual representation of digital content 405. Featured area 410 of digital content 405 is highlighted to indicate that featured area 410 is featured. In some embodiments, featured area 410 can be highlighted as a result of a user hovering over featured area 415.

To tag an interaction occurring on featured area 410, a user can select featured area 410 by, for example, clicking featured area 410. A specified interaction can be selected using dropdown box 420. As shown, three potential interactions are listed. A user can select one of the three listed interactions to tag the interaction for reporting.

Reporting interface 400 further includes textbox 415 enabling a user to include tagging data defining a title for the tagged interaction. A user can enter any desired title, which can be associated with the interaction and used for reporting.

Interactions tagged for reporting can be listed in reporting index 430. Reporting index 430 can include data identifying the tagged interactions. For example, the featured area, tagged interaction and title of the interaction can be listed.

FIG. 5A, and FIG. 5B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 5A illustrates a conventional system bus computing system architecture 500 wherein the components of the system are in electrical communication with each other using a bus 505. Exemplary system 500 includes a processing unit (CPU or processor) 510 and a system bus 505 that couples various system components including the system memory 515, such as read only memory (ROM) 520 and random access memory (RAM) 525, to the processor 510. The system 500 can include a cache of high-speed memory connected directly with, in close proximity to, or integrated as part of the processor 510. The system 500 can copy data from the memory 515 and/or the storage device 530 to the cache 512 for quick access by the processor 510. In this way, the cache can provide a performance boost that avoids processor 510 delays while waiting for data. These and other modules can control or be configured to control the processor 510 to perform various actions. Other system memory 515 may be available for use as well. The memory 515 can include multiple different types of memory with different performance characteristics. The processor 510 can include any general purpose processor and a hardware module or software module, such as module 1 532, module 2 534, and module 3 536 stored in storage device 530, configured to control the processor 510 as well as a special-purpose processor where software instructions are incorporated into the actual processor design. The processor 510 may essentially be a completely self-contained computing system, containing multiple cores or processors, a bus, memory controller, cache, etc. A multi-core processor may be symmetric or asymmetric.

To enable user interaction with the computing device 500, an input device 545 can represent any number of input mechanisms, such as a microphone for speech, a touch-sensitive screen for gesture or graphical input, keyboard, mouse, motion input, speech and so forth. An output device 535 can also be one or more of a number of output mechanisms known to those of skill in the art. In some instances, multimodal systems can enable a user to provide multiple types of input to communicate with the computing device 500. The communications interface 540 can generally govern and manage the user input and system output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof.

The storage device 530 can include software modules 532, 534, 536 for controlling the processor 510. Other hardware or software modules are contemplated. The storage device 530 can be connected to the system bus 505. In one aspect, a hardware module that performs a particular function can include the software component stored in a computer-readable medium in connection with the necessary hardware components, such as the processor 510, bus 505, display 535, and so forth, to carry out the function.

FIG. 5B illustrates a computer system 550 having a chipset architecture that can be used in executing the described method and generating and displaying a graphical user interface (GUI). Computer system 550 is an example of computer hardware, software, and firmware that can be used to implement the disclosed technology. System 550 can include a processor 555, representative of any number of physically and/or logically distinct resources capable of executing software, firmware, and hardware configured to perform identified computations. Processor 555 can communicate with a chipset 560 that can control input to and output from processor 555. In this example, chipset 560 outputs information to output 565, such as a display, and can read and write information to storage device 570, which can include magnetic media, and solid state media, for example. Chipset 560 can also read data from and write data to RAM 575. A bridge 580 for interfacing with a variety of user interface components 585 can be provided for interfacing with chipset 560. Such user interface components 585 can include a keyboard, a microphone, touch detection and processing circuitry, a pointing device, such as a mouse, and so on. In general, inputs to system 550 can come from any of a variety of sources, machine generated and/or human generated.

Chipset 560 can also interface with one or more communication interfaces 590 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 555 analyzing data stored in storage 570 or 575. Further, the machine can receive inputs from a user via user interface components 585 and execute appropriate functions, such as browsing functions by interpreting these inputs using processor 555.

It can be appreciated that exemplary systems 500 and 550 can have more than one processor 510 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A method comprising:
identifying, by a processor, within a source document defining presentation of digital content, at least a first featured area of the digital content;
presenting, by the processor, on a visual representation of the digital content, an indication that a first interaction on the first featured area can be tagged for reporting;
upon receiving a selection to tag the first interaction, creating, by the processor, a first entry in a reporting index associated with the digital content, the first entry:
identifying the first interaction on the first featured area tagged for reporting; and
including a first interaction count representing a number of times the first interaction with the first featured area has been detected.

2. The method of claim 1, further comprising:
generating a reporting script that can be placed into the source document, the reporting script configured to:
upon detecting user interaction with the digital content, transmit a reporting message including:
an identifier identifying the digital content, and
detection data describing a detected interaction on the digital content.

3. The method of claim 2, further comprising:
receiving the reporting message;
identifying the reporting index from the identifier identifying the digital content;
determining that the detected data describes the first interaction on the first featured area identified by the first entry of the reporting index; and
incrementing the first interaction count included in the first entry.

4. The method of claim 1, further comprising:
determining that the first featured area is configured to receive at least the first interaction and a second interaction;
presenting, on the visual representation of the digital content, a second indication that the second interaction of the first featured area can be tagged for reporting; and
upon receiving a selection to tag the second interaction, creating a second entry in a reporting index associated with the digital content, the second entry:
identifying the second interaction on the first featured area tagged for reporting; and
including a second interaction count representing a number of times the second interaction with the first featured area has been detected.

5. The method of claim 1, wherein identifying the least a first featured area of the digital content comprises:
scanning the digital content for tags or social cues indicating that a portion of the source document describes an featured area of the digital content.

6. The method of claim 1, further comprising:
in response to receiving a reporting request for the first interaction tagged for reporting, transmitting at least the first interaction count representing the number of times the first interaction with the first featured area has been detected, wherein the first interaction count can be visually rendered for reporting.

7. The method of claim 1, further comprising:
receiving tagging data describing the first interaction that was tagged for reporting, the tagging data received from a user that tagged the first interaction; and
recording the tagging data in the first entry.

8. A system comprising:
a processor; and
a memory containing instructions that, when executed, cause the processor to:
identify, within a source document defining presentation of digital content, at least a first featured area of the digital content;
present, on a visual representation of the digital content, an indication that a first interaction on the first featured area can be tagged for reporting;
upon receiving a selection to tag the first interaction, create a first entry in a reporting index associated with the digital content, the first entry:
identifying the first interaction on the first featured area tagged for reporting; and
including a first interaction count representing a number of times the first interaction with the first featured area has been detected.

9. The system of claim 8, wherein the instructions further cause the processor to:
generate a reporting script that can be placed into the source document, the reporting script configured to:
upon detecting user interaction with the digital content, transmit a reporting message including:
an identifier identifying the digital content, and
detection data describing a detected interaction on the digital content.

10. The system of claim 9, wherein the instructions further cause the processor to:
receive the reporting message;
identify the reporting index from the identifier identifying the digital content;
determine that the detected data describes the first interaction on the first featured area identified by the first entry of the reporting index; and
increment the first interaction count included in the first entry.

11. The system of claim 8, wherein the instructions further cause the processor to:
determine that the first featured area is configured to receive at least the first interaction and a second interaction;
present, on the visual representation of the digital content, a second indication that the second interaction of the first featured area can be tagged for reporting; and
upon receiving a selection to tag the second interaction, create a second entry in a reporting index associated with the digital content, the second entry:
identifying the second interaction on the first featured area tagged for reporting; and
including a second interaction count representing a number of times the second interaction with the first featured area has been detected.

12. The system of claim 8, wherein identifying the least a first featured area of the digital content comprises:
scanning the digital content for tags or social cues indicating that a portion of the source document describes an featured area of the digital content.

13. The system of claim 8, wherein the instructions further cause the processor to:
in response to receiving a reporting request for the first interaction tagged for reporting, transmit at least the first interaction count representing the number of times the first interaction with the first featured area has been detected, wherein the first interaction count can be visually rendered for reporting.

14. The system of claim 8, wherein the instructions further cause the processor to:
receive tagging data describing the first interaction that was tagged for reporting, the tagging data received from a user that tagged the first interaction; and
record the tagging data in the first entry.

15. A non-transitory computer-readable medium containing instructions that, when executed by a computing device, cause the computing device to:
identify, within a source document defining presentation of digital content, at least a first featured area of the digital content;
present, on a visual representation of the digital content, an indication that a first interaction on the first featured area can be tagged for reporting;
upon receiving a selection to tag the first interaction, create a first entry in a reporting index associated with the digital content, the first entry:
identifying the first interaction on the first featured area tagged for reporting; and
including a first interaction count representing a number of times the first interaction with the first featured area has been detected.

16. The non-transitory computer-readable medium of claim 15, wherein the instructions further cause the computing device to:
generate a reporting script that can be placed into the source document, the reporting script configured to:
upon detecting user interaction with the digital content, transmit a reporting message including:
an identifier identifying the digital content, and
detection data describing a detected interaction on the digital content.

17. The non-transitory computer-readable medium of claim 16, wherein the instructions further cause the computing device to:
receive the reporting message;
identify the reporting index from the identifier identifying the digital content;
determine that the detected data describes the first interaction on the first featured area identified by the first entry of the reporting index; and
increment the first interaction count included in the first entry.

18. The non-transitory computer-readable medium of claim 15, wherein the instructions further cause the computing device to:
determine that the first featured area is configured to receive at least the first interaction and a second interaction;
present, on the visual representation of the digital content, a second indication that the second interaction of the first featured area can be tagged for reporting; and
upon receiving a selection to tag the second interaction, create a second entry in a reporting index associated with the digital content, the second entry:
identifying the second interaction on the first featured area tagged for reporting; and
including a second interaction count representing a number of times the second interaction with the first featured area has been detected.

19. The non-transitory computer-readable medium of claim 15, wherein identifying the least a first featured area of the digital content comprises:
scanning the digital content for tags or social cues indicating that a portion of the source document describes an featured area of the digital content.

20. The non-transitory computer-readable medium of claim 15, wherein the instructions further cause the computing device to:
in response to receiving a reporting request for the first interaction tagged for reporting, transmit at least the first interaction count representing the number of times the first interaction with the first featured area has been detected, wherein the first interaction count can be visually rendered for reporting.
